(19) United States
(12) Patent Application Publication
(10) Pub. No.: US 2015/0334317 A1
(43) Pub. Date: Nov. 19, 2015

(54) HIGH DYNAMIC RANGE ARRAY OF SENSITIVE IMAGE SENSOR BLOCKS USING BLOCK PROCESSING

(71) Applicant: RJS TECHNOLOGY, INC., Hollis, NH (US)

(72) Inventor: Sorin Davidovici, Ocean Port, NJ (US)

(73) Assignee: RJS TECHNOLOGY, INC., Hollis, NH (US)

(21) Appl. No.: 14/367,415

(22) PCT Filed: Jan. 20, 2013
(86) PCT No.: PCT/US13/22347

§ 371 Date: Jun. 20, 2014

Related U.S. Application Data
(60) Provisional application No. 61/588,869, filed on Jan. 20, 2012.

(51) Int. Cl. H04N 5/355; H04N 5/235

(52) U.S. Cl. CPC H04N 5/355; H04N 5/35563; H04N 5/2355

(57) ABSTRACT

A method is disclosed of an image sensor array comprising more than one image sensor structures and one or more processing blocks that are interconnected. The final image sensor array image output for each image sensor structure or pixel is computed using single image sensor structure output data or output data from more than one image sensor structure and processing blocks. The image sensor array exhibits complexity, cost, power consumption, device yields and reliability benefits when compared to other image sensor array structures.

### RELATED INVENTIONS

This application is a U.S. national stage entry of PCT/US claims priority under 35 U.S.C. 1.120 to PCT/US2013/022347, filed Jan. 20, 2013.

### FIELD OF THE INVENTION

The present invention is related generally to the field of image sensor structures and more particularly to an image sensor array comprised of one or more active and/or passive image sensor structures such that a greatly extended voltage-to-light response can be obtained with each image sensor structure.

### BACKGROUND OF THE INVENTION

Photography is the process of making pictures by means of the action of light. Light is the commonly used term for electromagnetic radiation in a frequency range that is visible to the human eye. Light patterns reflected or emitted from objects are recorded by an image sensor through a timed exposure.

Image sensor structures can be chemical in nature, such as photographic film, or solid state in nature, such as the CCD and CMOS image sensor structures employed by digital still and video cameras. Digital cameras have a series of lenses that focus light to create an image of a scene. But instead of focusing the light onto a piece of film, as in traditional cameras, it focuses it onto the solid-state image sensor which converts the electromagnetic radiation of the light into an electrical charge. Solid state image sensor structures are frequently referred to as focal plane arrays.

The methods and techniques disclosed herein apply to the entire spectrum of electromagnetic radiation that is capable of creating a response in solid-state image sensor structures. This spectrum of electromagnetic radiation spans the set of frequencies contain within the visual range as well as frequencies of a lower as well as higher values.

FIG. 1 illustrates several components that may be included in one possible functional implementation 10 by which a natural scene is captured to form an electronic image. System 10 includes a signal source 100 and a signal processing chain that includes integrator 110, analog to digital converter (ADC) 120 and digital signal processor (DSP) 130.

The output of integrator 110, V_{OUT}, is input to ADC 120. ADC 120 performs the analog to digital conversion function. The analog to digital conversion function is well known in the art. The analog signal V_{OUT} that is present at the input of ADC 120 is converted into signal V_{D} that is present at the output of ADC 120. V_{D} can assume one of a set of discrete levels usually but not always measured in units of volts. By way of example another unit of measure for the output of ADC 120 can be amperes.

By way of example signal source 100 could be a light intensity sensor that is used in a timed application, such as in a digital camera application where the sensor is exposed to the incoming light for a specific duration of time that is commonly referred to as the exposure time. The integrator 110 then serves the function of integrating the responses of sensor 100 caused by all photons received during the exposure time into one output value to be read out at the end of the exposure time. By way of example the integrator 110 output value could be a voltage measured in units of volts.

FIG. 2 is a simplified illustration of a potential image sensor structure block diagram. Signal source 1000 is a light sensor that by way of example could be a photodiode. Component 1040 is a simple integrator that by way of example could be a capacitor. The input to the integrator is the output of signal source 1000. Integrator 1040 is reset by switch 1050 which is in the closed position prior to starting the integration process. The ability to rapidly reset the state of integrator 1040 is an important aspect of the image sensor operation. At the start of the integration process switch 1050 opens and the voltage across integrator 1040 begins to change in response to the input signal originating from signal source 1000. At the end of the integration process switch 1030 closes and integrator output 1060, V_{OUT}, is sampled. FIG. 2 is an illustrative diagram and the implementation of other similar image sensor structures with identical functionality is well known to one skilled in the art.

In an alternative and equivalent mode of operation of the simplified image sensor structure block diagram of FIG. 2 the integrator embodied by way of example by capacitor 1040 is reset by switch 1050 to a high voltage V+ or POWER instead of to V− or GROUND. At the start of the integration process switch 1050 opens and the voltage across integrator 1040 begins to change in response to the input signal originating from signal source 1000. At the end of the integration process switch 1030 closes and integrator output 1060, V_{OUT}, is sampled.

The simplified block diagram of an image sensor structure illustrated in FIG. 2 by way of example is subject to some performance limitations. One such limitation, the dynamic range, is described here by way of example together with an explanation that gives insight into its causes. The integrator output 1060, V_{OUT}, cannot in general exceed the upper limit imposed by the available power supply voltage. Power supply voltages are decreasing in state-of-the-art equipment due to stringent power consumption requirements. Integrator output 1060 cannot exceed the power supply voltage and will saturate if the integrator output signal attempts to build up after reaching the power supply voltage level.

Electronic means to multiply an input power supply voltage exist but are not efficient, introduce additional electronic noise, occupy silicon real estate, increase costs and decrease reliability and for these reasons are not preferred solutions.

Saturation occurs when the output voltage reaches the available power supply voltage and is unable to respond to further changes in the input signal. Signal saturation causes system performance degradation. FIGS. 3A through 3C illustrate potential distortions at the output of a pixel structure consisting of light sensor 100 and integrator 110 due to the dynamic range limitation of the photosensitive element structure and more specifically of the integrator structure. They also illustrate potential distortions at the output of light sensor 1000 and integrator output 1060 due to the dynamic range limitations. Segment (a) of FIG. 3(a) illustrates the linear increase of integrator 110 output in response to a constant input signal of different level. It also illustrates the linear increase of integrator output 1060 in response to a constant input signal of different level. The image sensor structure will perform well for the range of input light intensities that give rise to the linear output of segment (a); the image sensor structure will not perform well for the range of input light intensities that give rise to the saturated output of segment (b).

The integrator output response is indicative of limited dynamic range. As illustrated in FIG. 3(a) one version of the embodiment of the image sensor of FIG. 2 will render well shadow detail but will fail to render highlight detail. It is possible to shift the response as illustrated in FIGS. 3(b) and 3(c). In FIGS. 3(b) and 3(c) the dynamic range of the image sensor remains the same but the response characteristic is shifted. The response characteristic of FIG. 3(b) loses shadow and highlight detail but retains good midrange response. The response characteristic of FIG. 3(c) looses shadow detail and partial midrange detail in order to maintain good highlight detail.

FIG. 4A illustrates the histogram of the pixel intensities of an overexposed image capture where a multitude of light sensors (pixel) elements that were exposed to the image were driven into saturation. As seen in FIG. 4A the maximum image sensor structure output value is ‘255’ and the units used are the ADC 120 output corresponding to the image sensor output voltage. The light intensity caused many light sensors 100 to output a value that saturated the integrator 110 as the exposure progressed during the exposure period. The maximum (saturated) value of the output of integrator 110 caused the ADC to generate the output code ‘255’ which is the maximum output code for an 8-bit ADC. The image capture will be of lower than optimal quality due to the inability of those image sensor structures subject to high intensity light inputs to achieve a sufficiently high output level.

The distortion illustrated in the histogram of FIG. 4A corresponds to the individual image sensor distortion. A shorter exposure time would have caused the outputs of the image sensor structures subject to high intensity light inputs to register an output level below 255 and avoid the high end distortion but would have caused the image sensor structures subject to low intensity light inputs to remain at an output level value of 0 and not register the light intensity details contained in the shadows and other low light image segments.

FIG. 4B illustrates the histogram of the pixel intensities of an underexposed image capture where a multitude of image sensor structures were not exposed to sufficient light to achieve a minimum output value above ‘0’. As seen in FIG. 4B the minimum image sensor structure output value is ‘0’. The units refer to the ADC 120 output levels corresponding to individual image sensor structures. The light intensity received at the image sensor caused many individual light sensors 100 to output a value that failed to cause integrator 110 to output a sufficiently high value to cause a minimal ADC output code above ‘0’ as the exposure progressed during the exposure period. The image capture will be of lower than optimal quality due to the inability of those image sensor structures subject to low intensity light inputs to generate a sufficiently high response level. The distortion illustrated in the histogram of FIG. 4B corresponds to the individual pixel distortion. A longer exposure would have caused the outputs of the individual image sensor structures subject to low intensity light inputs to register an above ‘0’ output and avoid the low end distortion but would have also caused the image sensor structures subject to high intensity light inputs to saturate at a ‘255’ output value and not register the light intensity details contained in the highlights and other bright light image segments.

FIG. 5A illustrates the response of yet another of the two or more solid-state image sensor structures used to build the heterogeneous image sensor disclosed in this patent application. The extended dynamic range of the solid-state image sensor structure is sufficient to produce an image sensor response over the full range of electromagnetic radiation intensity impinging upon the image sensor structure. This enables the solid-state image sensor structure to capture sufficient charges in the darkest image portion, i.e. fewest reflected photons, while avoiding the saturation affects in the brightness portions, i.e., largest number of reflected photons, of the image to be captured. The net effect it is faithful reproduction of the image to be captured regardless of whether the light from the darkest segment or the light from the brightest segment of the scene to be captured is impinging upon the image sensor. FIG. 5B illustrates the histogram of the pixel intensities of a correctly exposed image capture where all image sensor outputs are within the dynamic range of the 8-bit ADC, that is ‘0’ to ‘255’.

Integrator saturation before the end of the exposure period is a limiting factor in the dynamic range of an image sensor structure. Solutions to the integrator saturation problem have been published. The feature the published solutions have in common is the monitoring of the integrator output to detect the onset of saturation condition at which time the integrator is discharged and the event is recorded.

By way of example of such solutions Mazzucco discloses in U.S. Pat. No. 6,407,610 methods to prevent saturation of the integrator output. The prevention methods consist of sensing the onset of saturation and resetting (discharging) the integrator or changing the direction of integration when the onset of saturation is sensed. An external circuit records all such events. At the end of the integration period the effective full range of the integration is reconstructed from the number of recorded reset events and from the final integrator output voltage. A similar approach is disclosed by Merill in U.S. Pat. No. 6,130,713.

All such solutions have in common the need to compensate for the dynamic range limitation inherent to the native image sensor structure. These solutions require the introduction of additional circuit elements into the image sensor structure in order to perform the functions outlined in the disclosures.

These solutions have in common the independent operation of each image sensor with respect to other image sensor structures and the need to incorporate the additional circuit elements into each image sensor capable of extended dynamic range performance. The introduction of the additional circuit elements causes complexity, cost and power consumption to increase while the device yields and reliability decrease.

### SUMMARY OF THE INVENTION

The present invention aims to disclose an image sensor array comprised of one or more active and/or passive image sensor structures such that a greatly extended voltage-to-light response can be obtained with each single image sensor structure.

The present invention further aims to disclose an image sensor array that is comprised of one or more distinct active and/or passive image sensor structures such that a greatly extended voltage-to-light response can be obtained from and by the image sensor structures in one single image scan.

The present invention further aims to disclose active and/or passive image sensor structures that interact with one or more additional image sensor structures such that a greatly extended voltage-to-light response can be obtained from and by the image sensor structures in one single image scan.

The present invention further aims to disclose interactions between two or more active and/or passive image sensor structures such that a greatly extended voltage-to-light response can be obtained from and by the image sensor structure in one single image scan.

The present invention further aims to disclose a method of capturing and generating an electronic image representation from an image sensor array of two or more image sensor structures that interact during the active image capture period that is sometimes but not always referred to as the ‘exposure’ period such that a greatly extended voltage-to-light response can be obtained in one single image scan from the image sensor that aggregates the image sensor structures.

Accordingly, besides the objects and advantages of the enhanced array of two or more image sensor structures described in herein, several objects and advantages of the present invention include, either singularly or in combination: to accurately capture the detail present in the darkest portions of the image to be captured in electronic format; to accurately capture the detail present in the brightest portions of the original image to be captured in electronic format; to accurately capture the detail present along all portions of the original image to be captured in electronic format; to operate with a dynamic range that is sufficiently large to electronically capture images of realistic scenes without losing accuracy at any point of the original scene and along the corresponding electronic signal range; to exhibit a transfer function response characteristic that is highly accurate and can be mapped into another and arbitrary transfer function response characteristic without losing accuracy at any point along the range of signals that comprise the electronic representation of the original nature scene; to exhibit a transfer function response characteristic that is highly accurate and can be mapped into another and arbitrary response characteristic without losing accuracy in any portion of the scene that is captured in the electronic image representation; to exhibit a transfer function response characteristic that can capture images of realistic nature scenes with sufficiently high accuracy to be matched to the transfer function response characteristic of one or more different display devices so that the original nature scenes look realistic and substantially identical to the original nature scenes when viewed on all display devices; to exhibit a transfer function response characteristic that is highly accurate and can be used to create archival records that contain sufficient highly accurate information to enable future processing for matching the archival image to various future display devices that will have improved characteristics so that the original nature scenes will look realistic and substantially identical to the original nature scenes when viewed on the future display devices; and to exhibit a response characteristic that is sufficiently accurate to enable the captured image to be effectively used in signal processing apparatus, such as facial recognition apparatus, quality inspection apparatus, scientific analysis apparatus and all other apparatus the performance of which depend on the quality of the electronic image capture of images visible in the spectral ranges to which the human eye is sensitive or in other spectral ranges to which the human eye is not sensitive and therefore the image would be invisible to the human eye. Further objects and advantages of the invention will become apparent from a consideration of the drawings and ensuing description.

### BRIEF DESCRIPTION OF THE DRAWINGS

FIG. 1 illustrates the simplified block diagram of a typical system used to capture and process electronic images in digital format.

FIG. 2 illustrates in block diagram format a simple integrator with control switches.

FIGS. 3(a), 3(b) and 3(c) illustrate the effects that limited dynamic range might have upon the output of a simple typical image sensor.

FIGS. 4(a) and 4(b) illustrate in histogram format the effects that limited dynamic range might have upon the output of a typical image sensor array.

FIG. 5(a) illustrates the output of an image sensor that does not suffer from dynamic range limitations.

FIG. 5(b) illustrates in histogram format the output of a typical image sensor array that does not suffer from dynamic range limitations.

FIG. 6 illustrates a hypothetical image sensor block consisting of heterogeneous image sensor structures and the interconnections between the image sensor structures.

FIG. 7 illustrates a potential output of a lower dynamic range image sensor structure of an image sensor block as a function of time.

FIG. 8 illustrates a well known test picture that is used to illustrate the image capture quality of a sample heterogeneous image sensor array.

FIG. 9(a) illustrates the electronic image generated by a first sample process from the output of the image sensor array comprised of a multitude of image sensor blocks.

FIG. 9(b) illustrates the difference between the original image and the image generated from the output of the image sensor array.

FIG. 10(a) illustrates an image sensor array comprised entirely of image sensor structures.

FIG. 10(b) illustrates an image sensor array comprised entirely of image sensor blocks.

FIG. 10(c) illustrates an image sensor array comprised of a mix of image sensor structures and image sensor blocks.

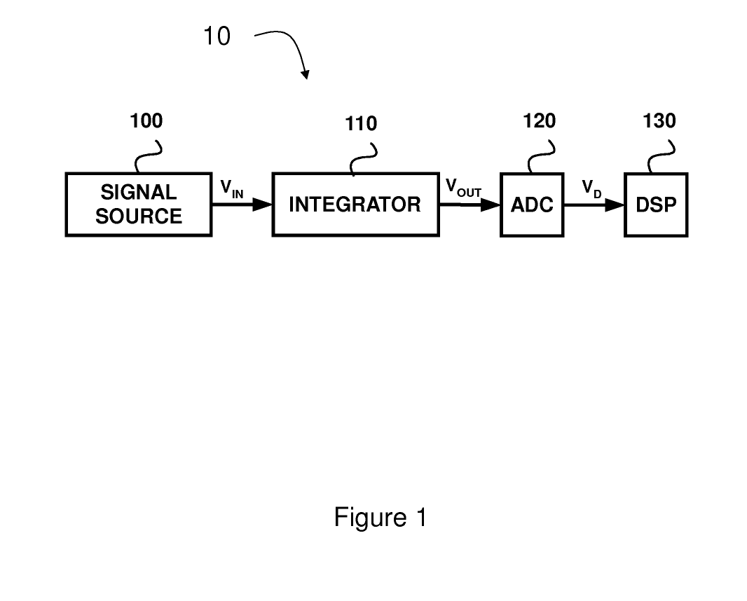

### DETAILED DESCRIPTION OF THE INVENTION

According to one aspect of the invention, an image sensor array is described that in some applications may also be referred to as a focal plane array (FPA). It comprises individual image sensor structures that in some applications may also be referred to as focal plane detectors (FPD). FPAs and FPDs are well known to one versed in the art.

The image sensor array is comprised of image sensor blocks and each image sensor block consists of a number of image sensor structures. The number of image sensor structures in an image sensor block is at least one. The image sensor blocks may be of varying types. Thus, there can be as many image sensor blocks in the image sensor array as there are image sensor structures, meaning that each individual image sensor block can be comprised of a single image sensor structure or multiple image sensor structures. The number of image sensor blocks and the number of image sensor structures within each image sensor block in the image sensor array can vary and will be determined by the requirements of specialized applications of the apparatus that contains the image sensor array.

The image sensor array is not constrained to be contained on a single fabricated device. In one embodiment of an image sensor array, two or more image sensor blocks could be operating jointly and not independently. Thus an image sensor array can be fabricated and housed in different devices but connections to image sensor blocks will be implemented so that the image sensor blocks are not restricted to operate independently. Other potential implementation architectures for image sensor arrays, wherein two or more image sensor blocks operate independently are possible and known to those skilled in the art.

In an exemplary embodiment, two or more of the image sensor structures that comprise the image sensor block interact during the image capture period. The current disclosure contemplates an embodiment of an image sensor array comprised of two or more image sensor blocks, each image sensor block having at least two image sensor structures.

The image sensor blocks may have more circuit elements than the corresponding number of individual image sensor structures. The image sensor blocks therefore may have differing levels of functionality than the individual image sensor structures. Generally the more complex image sensor blocks that comprise the image sensor array will have functionality that is not present in the individual image sensor structures; thus the image sensor blocks are able to obtain information that is not available to the less complex image sensor structures, but which may, with the present invention, be shared with the less complex image sensor structures.

The image sensor array disclosed herein is capable of producing high-quality electronic images with high dynamic ranges even though the image sensor structures that comprise it are not individually capable of such high performance. This capability is derived from the arrangement and interactions of individual image sensor structures during the image capture stage.

The native or inherent dynamic range performance of an image sensor structure is governed by factors such as fabrication materials, design geometry, etc. The native dynamic range of an image sensor structure can be increased by adding circuit elements to perform functions not normally available in image sensor structures not modified for high dynamic range performance. By way of example of such additional functions Mazzucco discloses in U.S. Pat. No. 6,407,610 sensing the onset of saturation and resetting (discharging) the integrator or changing the direction of integration when the onset of saturation is sensed. Similar functions are disclosed by Merill in U.S. Pat. No. 6,130,713.

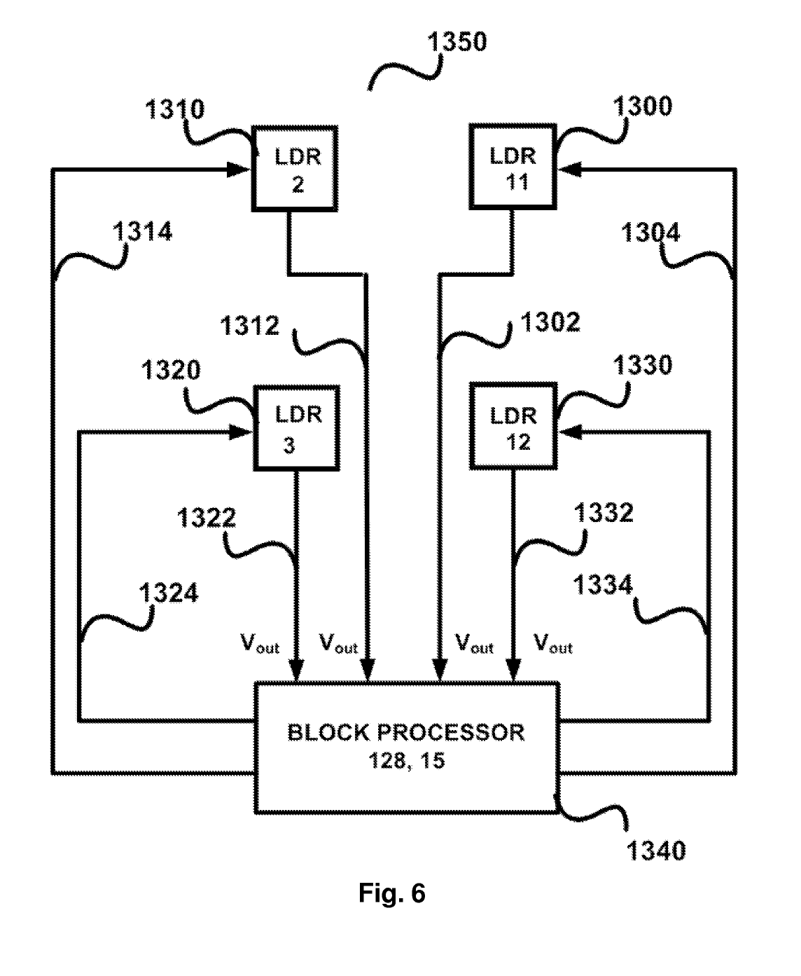

FIG. 6 illustrates an image sensor block 1350 that consists of four LDR image sensor structures 1300, 1310, 1320 and 1330 and a block processor 1340. An image sensor array may contain only image sensor structures, only image sensor blocks or any combination of image sensor structures and image sensor blocks.

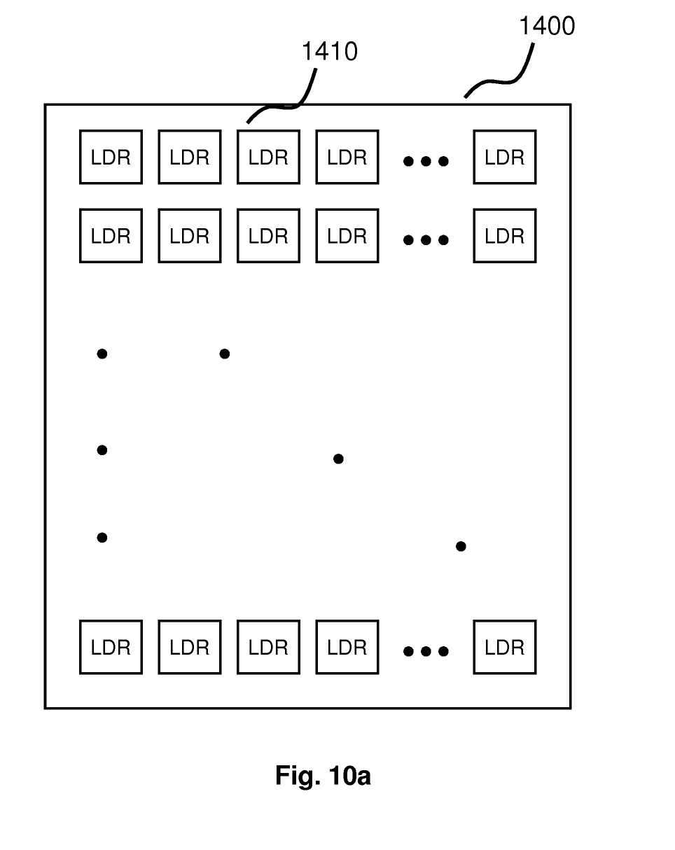

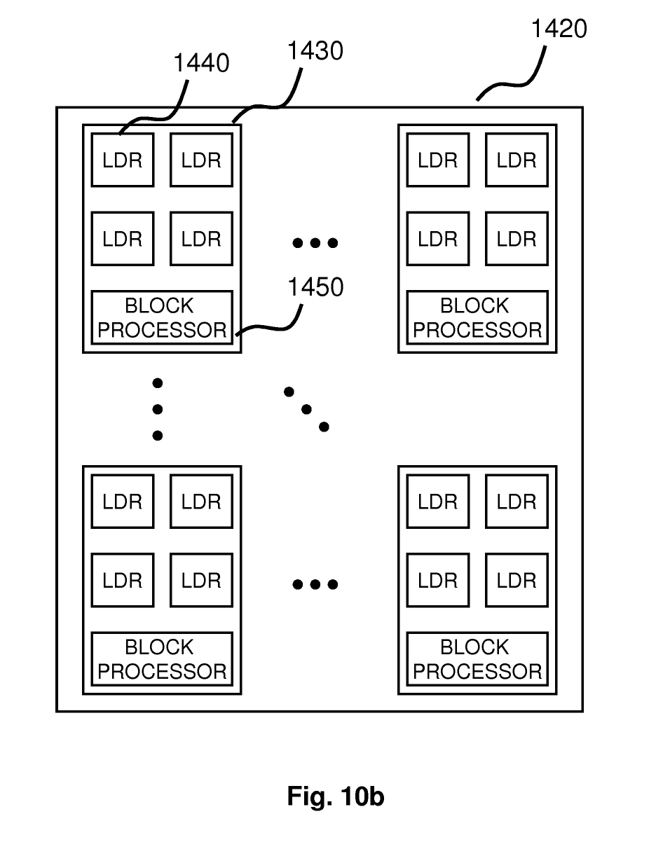

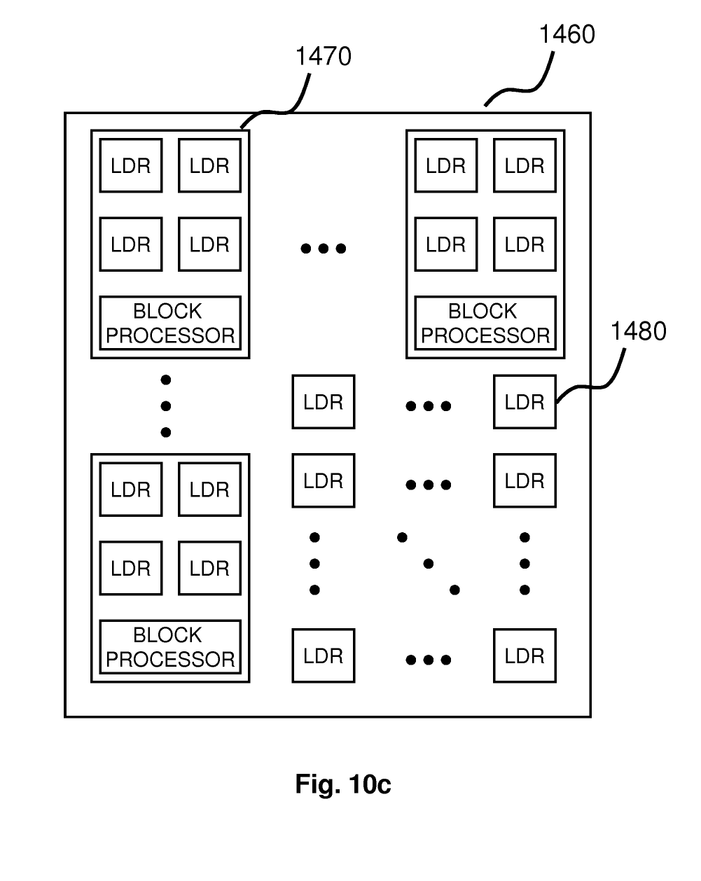

FIG. 10(a) illustrates image sensor array 1400 comprised of image sensor structures. Image sensor array 1400 is comprised of a number of image sensor structures of which image sensor structure 1410 is one.

FIG. 10(b) illustrates image sensor array 1420 comprised of image sensor blocks. Image sensor block 1430 is a typical image sensor block comprised of a number of image sensor structures and a processor block. By way of example FIG. 10(b) shows four image sensor structures that comprise image sensor block 1430 of which image sensor structure 1440 is one.

FIG. 10(c) illustrates image sensor array comprised of a mix of image sensor structures and image sensor blocks. Image sensor array 1460 is comprised of a number of image sensor blocks of which image sensor block 1470 is one and of a number of image sensor structures of which image sensor structure is 1480 is one.

An image sensor array may contain any number of image sensor blocks. The smallest number of image sensor blocks that may be contained in an image sensor array is one. The largest number of image sensor blocks that may be contained in an image sensor array is equal to the number of image sensor structures contained within the image sensor array.

An individual image sensor block can contain any number of image sensor structures. The minimum number of image sensor structures that can be contained within an image sensor block is one image sensor structure. The maximum number of image sensor structures that can be contained within an image sensor block equals the number of image sensor structures contained within the image sensor array.

Any two or more image sensor blocks may contain an equal or different number of image sensor structures. By way of illustration image sensor block 1350 contains four image sensor structures. Other image sensor blocks may contain two, three, five or more image sensor structures.

An individual image sensor block contains one or more block processor structures. By way of illustration FIG. 6 shows image sensor block 1350 that contains one block processor structure 1340. An image sensor blocks can contain two, three or more block processor structures and any two or more image sensor blocks can contain different numbers of block processor structures.

An image sensor block contains one or more signal buses. By way of illustration FIG. 6 shows image sensor block 1350 that contains signal buses 1302, 1312, 1322 and 1332 between image sensor structures 1300, 1310, 1320 and 1330 and block processor 1340 and signal buses 1304, 1314, 1324 and 1334 between block processor 1340 and the image sensor structures 1300, 1310, 1320 and 1330.

Signal buses 1302, 1312, 1322 and 1332 and signal buses 1304, 1314, 1324 and 1334 that are shown by way of illustration in FIG. 6 may consist of single analog signal lines, of single digital signal lines, of multiple analog signal lines, of multiple digital signal lines or of any combination of analog and digital signal lines. The design and implementation of signal buses is well known to one versed in the art.

Signal buses 1302, 1312, 1322 and 1332 shown by way of illustration in FIG. 6 need not be identical or similar to each other. By way of example signal bus 1302 may consist of a single analog signal line while signal buses 1312, 1322 and 1332 may consist of a single analog signal line and multiple digital signal lines. Any of the 1302, 1312, 1322 and 1332 signal buses illustrated in FIG. 6 may consist of single analog signal lines, of single digital signal lines, of multiple analog signal lines, of multiple digital signal lines, of a mixture of analog and digital signal lines or of any combination of analog and digital signal lines.

Signal buses 1304, 1314, 1324 and 1334 shown by way of illustration in FIG. 6 need not be identical or similar to each other. By way of example, signal bus 1304 may consist of a single analog signal line while signal buses 1314, 1324 and 1334 may consist of a single analog signal line and multiple digital signal lines. Any of the 1304, 1314, 1324 and 1334 signal buses illustrated in FIG. 6 may consist of single analog signal lines, of single digital signal lines, of multiple analog signal lines, of multiple digital signal lines, of a mixture of analog and digital signal lines or of any combination of analog and digital signal lines.

A block processor connects to one or more image sensor structures. By way of illustration block processor 1340 of FIG. 6 is connected to image sensor structures 1300, 1310, 1320 and 1330 through signal buses 1302, 1312, 1322, 1332, 1304, 1314, 1324 and 1334. Block processor 1340 receives information and data associated with image sensor structures 1300, 1310, 1320 and 1330 through signal buses 1302, 1312, 1322 and 1332 and sends data and commands to image sensor structures 1300, 1310, 1320 and 1330 through signal buses 1304, 1314, 1324 and 1334.

Block processor 1340 can receive any information and data from the image sensor structures that connect to it. The block processor can send any information and data to the image sensor structures that it connects to. By way of example, block processor 140 of FIG. 6 receives information and data that describe the state and status of image sensor structures 1310, 1320, 1330 and 1340 through signal buses 1302, 1312, 1322 and 1332 and sends reset commands to image sensor structures 1310, 1320, 1330 and 1340 through signal buses 1304, 1314, 1324 and 1334.

Image sensor structures 1310, 1320, 1330 and 1340 can proceed to enter a reset operation upon receiving reset commands from block processor 1340 through signal buses 1304, 1314, 1324 and 1334. The reset operation prevents output voltages 1302, 1312, 1322 and 1332 from entering into the range of output values that constitute the output saturation state. The implementation of image sensor structures reset operations are well known to one skilled in the art.

Block processors can process any number of data and information items originating from image sensor structures, from sources external to image sensor structures or from a combination of image sensor structures and sources external to image sensor structures. By way of example block processor 1340 processes data and information related to the output state of image sensor structures 1310, 1320, 1330 and 1340 that are connected to it through signal buses 1302, 1312, 1322 and 1332.

Block processors can process data and information items originating from image sensor structures, from sources external to image sensor structures or from a combination of image sensor structures and sources external to image sensor structures in a large variety of ways to derive the information and commands originating from it. Such processing algorithms and methods are known to those versed in the art. By way of example block processor 1340 can process the data and information originating from and related to image sensor structures 1310, 1320, 1330 and 1340 that are connected to it through signal buses 1302, 1312, 1322 and 1332 in accordance to an algorithm labeled Algorithm_1) as follows:
(1) Read signals output from image sensor structures 1310, 1320, 1330 and 1340 and labeled ‘V_{OUT}’ in FIG. 6 from signal buses 1302, 1312, 1322 and 1332
(2) Sum the quantities read out through signal buses 1302, 1312, 1322 and 1332 to form the sum signal SIGNAL_{SUM}=SIGNAL₁₃₀₂+SIGNAL₁₃₁₂+SIGNAL₁₃₂₂+SIGNAL₁₃₃₂ where SIGNAL₁₃₀₂, SIGNAL₁₃₁₂, SIGNAL₁₃₂₂, SIGNAL₁₃₃₂ refer to the ensemble of quantities available through signal buses 1302, 1312, 1322 and 1332 and labeled ‘V_{OUT}’ in FIG. 6.
(3) Compare the SIGNAL_{SUM} to a reference signal SIGNAL_{REFERENCE}
(4) If SIGNAL_{SUM} is smaller than the reference signal SIGNAL_{REFERENCE}, SIGNAL_{SUM}<SIGNAL_{REFERENCE}, do nothing.
(5) If SIGNAL_{SUM} is larger than or equal to the reference signal SIGNAL_{REFERENCE}, SIGNAL_{SUM}>=SIGNAL_{REFERENCE}, than block processor 1340 issues commands to image sensor structures 1310, 1320, 1330 and 1340 through signal buses 1304, 1314, 1324 and 1334 that cause image sensor structures 1310, 1320, 1330 and 1340 to enter into a reset cycle.
(6) The reset cycle will cause image sensor structures 1310, 1320, 1330 and 1340 and the ensemble of output quantities that are labeled ‘V_{OUT}’ in FIG. 6 to take a specific set of values. By way of example one such set of values can be that set of values that is referred to as the ‘initial set of values’.

The value of SIGNAL_{REFERENCE} will be set according to specifics of the image sensor array design, of the image sensor structure design, of the specific application of the image sensor array and according to other parameters that are well known to one versed in the art. By way of example, one particular value of SIGNAL_{REFERENCE} may be that image sensor structure output value that indicates that the image sensor structure is about to enter or has just entered its saturation state.

By way of example if image sensor structures 1300, 1310, 1320 and 1330 contain an oscillator and the output state of the image sensor structure is given by an integration process that determines the phase traversed by the oscillator output, (such as the image sensor structure shown described in U.S. Pat. No. 7,605,355 (incorporated herein by reference)) SIGNAL_{REFERENCE} can be determined to be that value that indicates that the phase traversed by the oscillator output increased by a predetermined quantity. Oscillators are standard circuits well known to those well versed in the art, although used in a novel manner in the '355 patent for image capture.

A block processor can use one or more values of SIGNAL_{REFERENCE} according to specifics of the image sensor array design, of the image sensor structure design, of the specific application of the image sensor array and according to other parameters that are well known to one versed in the art. SIGNAL_{REFERENCE} values associated with a block processor may differ from SIGNAL_{REFERENCE} values associated with a different block processor.

If the signal output quantities associated with image sensor structures 1300, 1310, 1320 and 1330 are voltage levels than the quantities labeled SIGNAL_{REFERENCE}, SIGNAL_{SUM}, SIGNAL₁₃₁₂, SIGNAL₁₃₁₂, SIGNAL₁₃₂₂ and SIGNAL₁₃₃₂ will be measured in units of volts.

A block processor has associated with it a memory structure with a functionality that enables it to record numbers of occurrence of events of interest. By way of example such events of interest might be the number of times that the block processor issued commands to image sensor structures interconnected to it. The memory function can record the values of interest in analog format, in digital format or in a combination of analog and digital formats. By way of example a digital circuit that can be used for the purpose of the recording is a digital counter. A digital counter changes its design states in response to an input signal. Common digital counters outputs are comprised of a number of output signal lines each able to take on two values that represent a logic LOW or logic HIGH. A digital counter output comprised of M lines is capable of L=2^{M} combinations and is therefore capable of counting up to L=2^{M} events in response to external inputs. Digital counters are well known to one versed in the art.

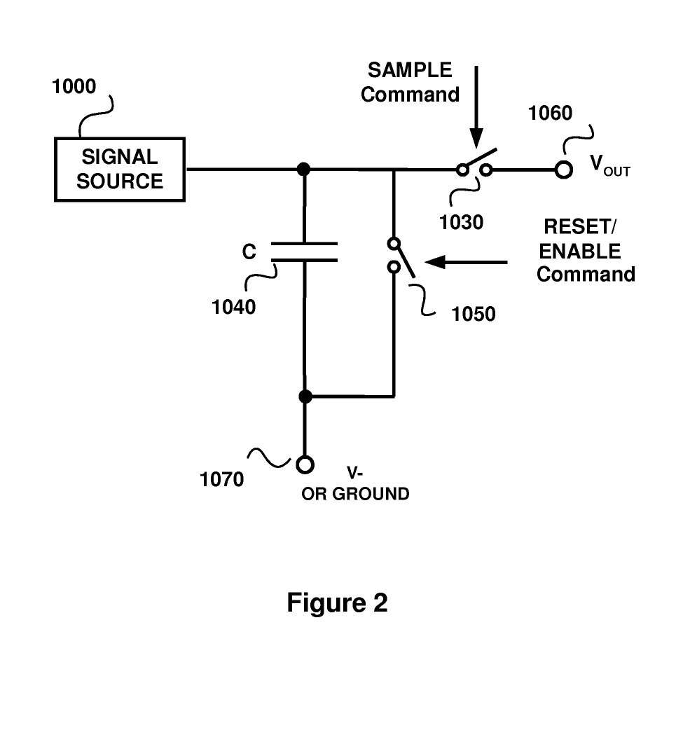

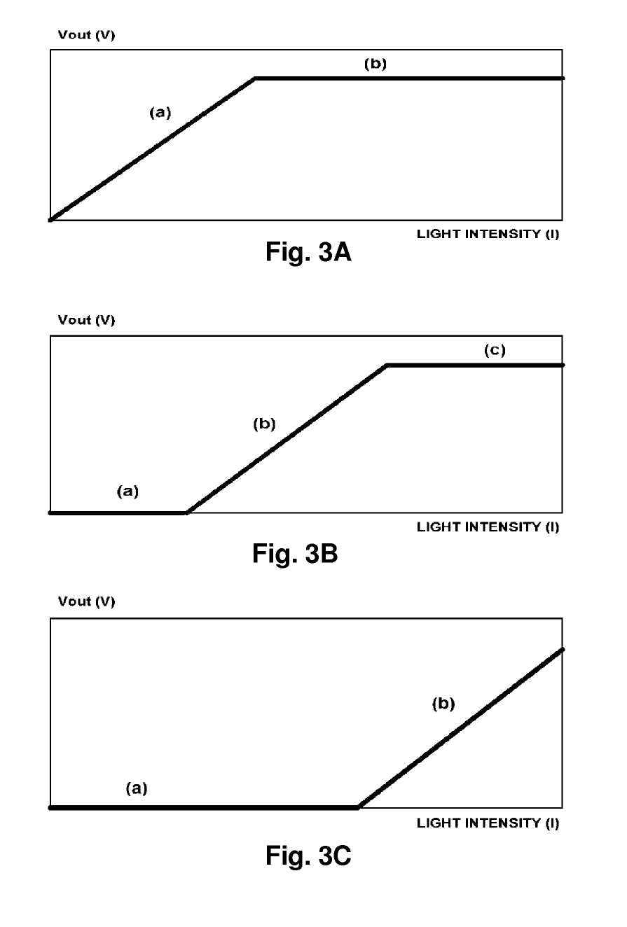

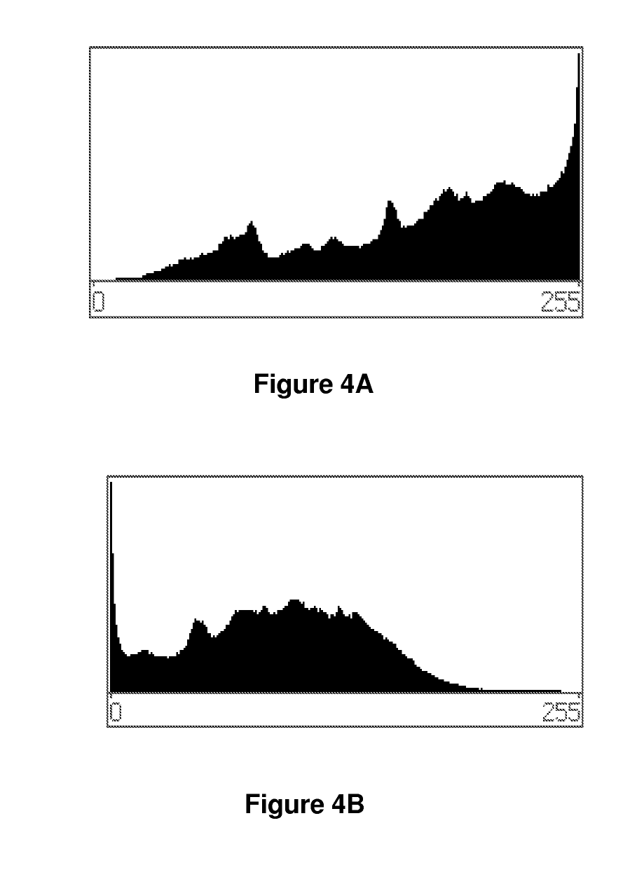

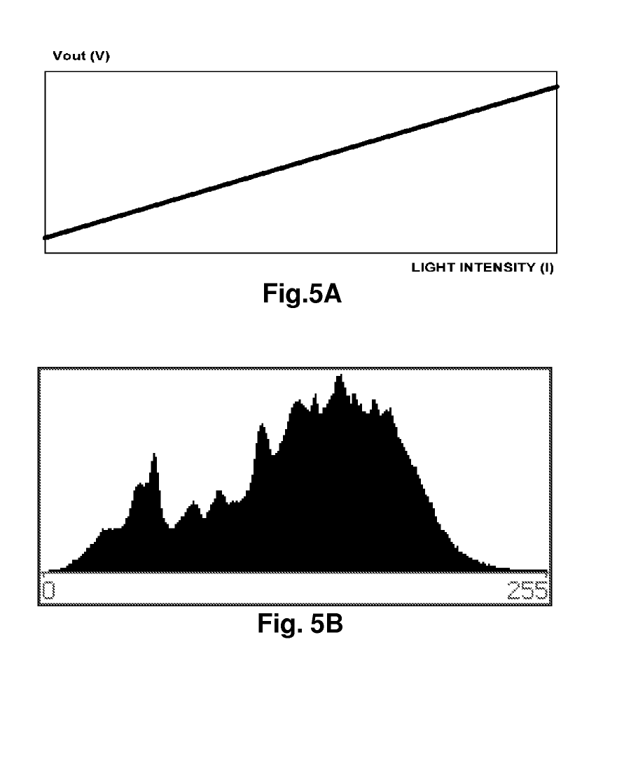

By way of yet another example an analog circuit that can be used for the purpose of the recording is an energy storing element. The output of an energy storing element changes value in response to external inputs. An energy storing element is illustrated by way of example ion FIG. 2. The output of the energy storing element 1040 illustrated by way of example in FIG. 2 changes value in response to the signal that originates from the signal source 1000. If a signal source such as signal source 1000 generates a signal pulse applied to the energy storing element input every time the block processor issued commands to image sensor structures interconnected to it the energy storing element output will be an analog value proportional to that number of times that the block processor issued commands to image sensor structures interconnected to it. The output value of the energy storing element 1040 can be read at such time that the sample command closes switch 1030. The functionality associated with the energy storing element can reside physically within the block processor or it can reside physically external to it. Energy storing element and pulse signal sources are well known to one well versed in the art.

Digital counters are relatively large circuits to implement and are expensive in terms of silicon real estate required for implementation. Analog counters and storage devices are alternative and advantageous means to implement memory structures with functionality that enable the recording of the number of times that the block processor issued commands to image sensor structures interconnected to it. Pulse signal sources and energy storing elements are examples of such analog types of devices and are well known to those versed in the art.

By way of example let an analog counter and analog storage device have an output labeled V that changes in discrete increments ΔV in response to the occurrence of external events to be counted. By way of example such an output can start from an initial value V_{MIN} and increase by discrete values of ΔV to V_{MIN}+ΔV, V_{MIN}+2 ΔV, V_{MIN}+3 ΔV and so on until it reaches a maximal value V_{MAX} volts. By way of yet another example it can start from an initial value V_{MAX} volts and decrease by discrete values ΔV to V_{MAX}−ΔV, V_{MAX}−2 ΔV, V_{MAX}−3 ΔV and so on until it reaches a minimum value V_{MIN} volts. Knowledge of the initial output value V_{MIN} or V_{MAX} together with knowledge of the state of the output value at any given time can be used to derive the number of discrete increments or decrements of value ΔV that occurred and therefore the number of external events of interest that were counted.

Analog storage means are advantageous in many circumstances. Current fabrication processes are able to fabricate analog counting and storage means in collocation with other circuit elements such as transistors. The collocation of analog counting and storage means and devices with other circuit elements is made possible by multiple layer techniques used in the design and fabrication of integrated circuits. These techniques are well known to one skilled in the art and are advantageous as they reduce the silicon area required to build the image sensor structure and image sensor arrays.

The collocation of analog storage devices during fabrication can be achieved by placing the analog storage device in a layer located above other circuit elements during the fabrication process. Alternately the collocation of the analog storage device can be achieved by placing the analog storage device in a layer located under other circuit elements during the fabrication process.

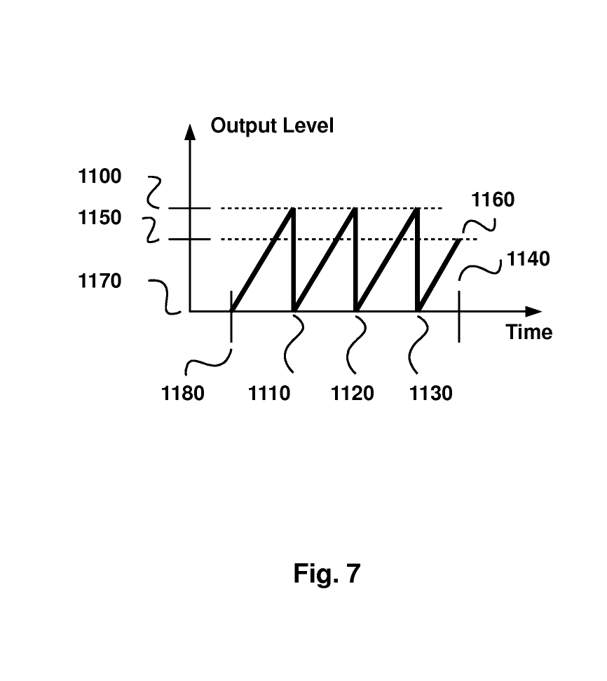

The operation of image sensor structures 1300, 1310, 1320 and 1330 will be affected by signal bus signals 1302, 1312, 1322 and 1332 and by signal bus signals 1304, 1314, 1324 and 1334. Independent operation of image sensor structures 1300, 1310, 1320, 1330 is different from interdependent and interconnected operation. By way of example the output of one of the image sensor structures in such mode of operation is illustrated in FIG. 7. Time instance 1180 marks the beginning of the image capture period when image sensor structures 1300, 1310, 1320 and 1330 are first exposed to external electromagnetic radiation of a frequency that causes the solid state material of the image sensor structure to exhibit a response. By way of example this response is illustrated here to be an increase of the output level of the image sensor structure as electromagnetic radiation impinges upon it. The output of the image sensor structure at time instances labeled 1110, 1120 and 1130 is indicated by the level marked 1100 immediately prior to the reset actions. The output state at time instances 1110, 1120 and 1130 of other image sensor structures that comprise the image sensor array may be different than the output level marked 1100.

The output level at time instances 1110, 1120 and 1130 of each image sensor structure that comprise an image sensor block may be lower or equal to a signal labeled SIGNAL_{REFERENCE}, the threshold value illustrated by way of example above to be used by the block processor.

By way of example illustrated in FIG. 7 the output state of the image sensor structures changes to the level labeled 1170 following the reset cycle. The level labeled 1170 can be GROUND, ‘0’ volts or any other any predetermined value.

Time instance 1140 marks the end of the image capture period. At that time the output level of one of the image sensor structures is indicated by way of example as the output level marked 1150. The output level of other image sensor structures at time instance 1140 may be different from the output level marked 1150.

The output information of all image sensor structures contained within the image sensor block is retrieved at the end of the image capture period marked in FIG. 7 as time instance 1140. The output information associated with block processor 1340 is also retrieved at the end of the image capture period marked in FIG. 7 as time instance 1140. The total information retrieved is processed to generate the electronic image captured by the image sensor block.

The output state of the image sensor structures can consist of any number of information items. By way of example one item of information retrieved from image sensor structures is their output levels at time instance 1140. In the example illustrated in FIG. 7 one such output level is labeled 1150. Another item of information retrieved from image sensor structures is the output levels reached at time instances 1110, 1120 and 1130 immediately prior to entering a reset cycle. In the example illustrated in FIG. 7 one such output level is labeled 1100. The information defining the output state of the LDR image sensor structures is not limited to the items given here by way of example; it can consist of any number of items of information that are well known to one skilled in the art.

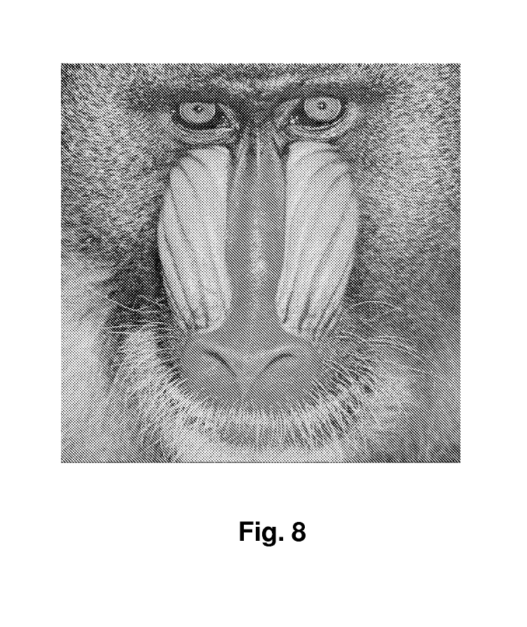

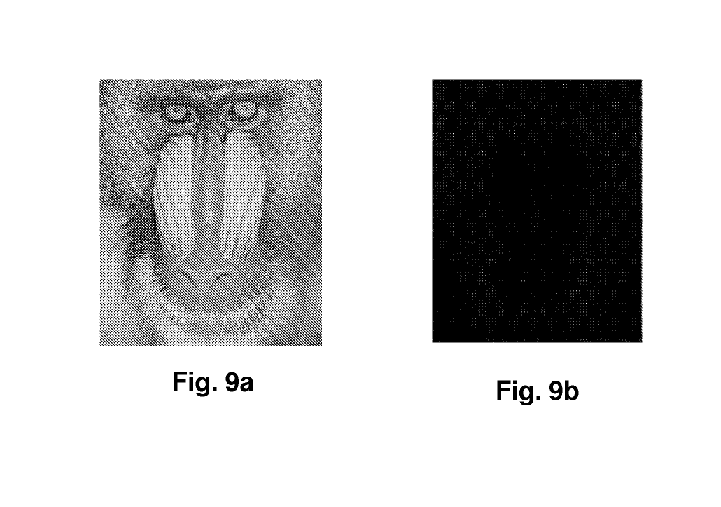

One process that can be used to generate the electronic image from the items of information generate by the image sensor block is illustrated below by way of example. This process labeled PROCESS_1 is described for the image sensor block of FIG. 6 as follows:
(1) Assuming that the image sensor structure has a single output quantity that is measured in volts, then retrieve the voltage V_{FINAL} reached by each image sensor structure at the termination of the exposure time. FIG. 7 illustrates that output level for one such image sensor structure to be the level labeled 1150. The output level voltage can take any value in the output range defined by the level labeled 1170 in FIG. 7 and V_{SAT} where V_{SAT} defines the image sensor structure saturation voltage level. In FIG. 6 the output levels for image sensor structures 1300, 1310, 1320 and 1330 are 11, 2, 3 and 12 respectively.
(2) An optional image sensor structure output item is the output value V_{RST} that is reached immediately prior to entering the reset cycle. Assuming the mode of operation illustrated by way of example in Algorithm_1 and assuming that SIGNAL_{REFERENCE}=V_{SAT}, the output value V_{RST} will be the output value associated with an image sensor structure output that is reached at that time when the sum of all LDR image sensor outputs reached V_{SAT}. FIG. 7 illustrates one such output level for one image sensor structure to be the level labeled 1100.
(3) Retrieve the level V_{SAT} and the number of times the sum of the image sensor structures reached the level V_{SAT}, N_{SAT}, from the block processor. In FIG. 6 the value of V_{SAT} is 128 and the value N_{SAT} is 15.
(4) For each image sensor structure calculate the fraction represented by its V_{FINAL} output level from the sum of all V_{FINAL} output levels reached by the image sensor structures. For the i-th image sensor structure that fraction is calculated by Fⁱ=Vⁱ_{FINAL}/sum (V¹_{FINAL}+V²_{FINAL} . . . +Vⁱ_{FINAL} . . . +V^{N}_{FINAL}) where N represents the number of image sensor structures in the image sensor block. For the values illustrated in FIG. 6 the values of Fⁱ are 0.39, 0.07, 0.11 and 0.43 for image sensor structures 1300, 1310, 1320 and 1330 respectively and the value of N is 4.
(5) If the optional image sensor structure output value V_{RST} is available then for each LDR image sensor calculate the fraction represented by its V_{RST} output level from the sum of all V_{RST} output level reached by all LDR image sensor structures. For the i-th LDR image sensor that fraction is calculated by Fⁱ=Vⁱ_{RST}/sum(Vⁱ_{RST}+V²_{RST} . . . +Vⁱ_{RST} . . . +V^{N}_{RST}).
(6) For each LDR image sensor compute a final output level according to Vⁱ_{OUT}_{_{—}}_{LDR}=N_{SAT}*Fⁱ*V_{SAT}+V_{FINAL}. For the value illustrated in FIG. 6 the values of Vⁱ_{OUT}_{_{—}}_{LDR} are 765.29, 139.14, 208.71 and 834.86 for LDR image sensor structures 1300, 1310, 1320 and 1330 respectively. Note that the final LDR image sensor output values can be far greater than V_{SAT} indicating the extension of the intrinsic image sensor structure saturation value.
   Other processes exist and are well-known to those skilled in the art. FIG. 8 illustrates a well-known test picture and FIGS. 9A and 9B illustrate the electronic image capture achievable by the image sensor block using the image signal block processing given here by way of example.

The present invention is related to a method for obtaining a read-out signal of a lower dynamic range solid-state image sensor structure, including CMOS and MOS based image sensor structures, having at least a photosensitive element with an output node, means to reset the output node signal and means to read out the output node signal.

Accordingly systems and methods have been described for the creation of electronic images using image sensor blocks, where each individual image sensor block content is generated as a function of the information captured by two or more image sensor structures and block processors during one single image scan, or exposure.

Having described various embodiments of the invention, it will be appreciated that although certain components and process steps have been described the descriptions are representative only; other functional delineations or additional steps and components can be added by one of skill in the art, and thus the present invention should not be limited to the specific embodiments disclosed. The various representational elements may be implemented in hardware, software running on a computer, or a combination thereof and modification to and variation of the illustrated embodiments may be made without departing from the inventive concepts herein disclosed. Accordingly, the invention should not be viewed as limited except by the scope and spirit of the appended claims.

What is claimed is:

1. An image sensor array comprising:
(a) at least two image sensor structures, each sensitive to electromagnetic radiation, used to sense electromagnetic radiation from an external scene during image capture and from this sensing create an electronic representation of the external scene; and
(b) at least one block processor coupled to the at least two image sensor structures to exchange information with the image sensor structures during image capture.

2. The image sensor array of claim 1 wherein said image sensor array is sensitive to at least one electromagnetic radiation frequency range selected from a group including a range of frequencies visible by a human eye, a range of frequencies lower than a range of frequencies visible by a human eye and a range of frequencies higher than a range of frequencies visible by a human eye.

3. An image sensor array comprising a plurality of individual image sensor structures each sensitive to electromagnetic radiation used to sense electromagnetic radiation from an external scene and from this sensing create the electronic representation of the external scene, the improvement including organizing said plurality of image sensor structures into groups of image sensor structures forming image sensor blocks.

4. The image sensor array of claim 3 wherein each image sensor block has a common number of image sensor structures.

5. The image sensor array of claim 3 wherein two or more of said image sensor blocks contain a number of image sensor structures that is different than the number of image sensor structures contained by the remaining image sensor blocks.

6. An image sensor block comprised of a plurality of image sensor structures, at least one block processor, and at least one signal bus coupling at least one of the plurality of images sensors to the at least one block processor.

7. The image sensor block of claim 6 wherein said block processor exchanges information with one or more of said image sensor structures over the at least one signal bus.

8. The image sensor block of claim 6 wherein the at least one signal bus comprised of one or more signals.

9. The image sensor block of claim 8 wherein the one or more signals are each coupled to one or more of the image sensors.

10. A method of deriving a high fidelity electronic image representation using an image sensor array where two or more individual image sensor structures and one or more processing blocks have the means to exchange information and coordinate states during the image acquisition process.
